(19) United States
(12) Patent Application Publication
(10) Pub. No.: US 2006/0143607 A1
(43) Pub. Date: Jun. 29, 2006

(54) Method and system for allowing a user to create actions to be taken by a server

(76) Inventor: Robert P. Morris, Raleigh, NC (US)

Correspondence Address: IPAC, 111 Corning Road, Suite 220, Cary, NC, 27511, US

(21) Appl. No.: 11/027,823

(22) Filed: Dec. 29, 2004

(51) Int. Cl. G06F 9/445

(52) U.S. Cl. 717/176

(57) ABSTRACT

A method and system are provided for allowing a user to create actions to be taken by a server. One aspect of the present invention includes; in response to a user accessing the server from a client device, providing the user with an option to create an action item, wherein the action item represents an action that can be taken with respect to at least one data object accessible to the server; enabling the user to associate an executable software object with the action item; and in response to the server receiving an identification of the action item and an identification of at least one data object, invoking the executable software object associated with the identified action item for automatically performing the action selected by the user on the at least one data object.

### CROSS-REFERENCE TO RELATED APPLICATIONS

The present invention is related to co-pending U.S. patent application Ser. No. 09/626,418 entitled “Method and System for Allowing a User to Select Actions to be Taken by a Server When Uploading the Images,” filed on Jul. 26, 2000, and incorporated herein by reference; and co-pending U.S. patent application Ser. No. ______ entitled “Method And System for Allowing a User to Specify Actions that are to be Automatically Performed on Data Objects Uploaded to a Server,” filed on Dec. 29, 2004, and incorporated herein by reference.

### FIELD OF THE INVENTION

The present invention relates to automatic processing of files, and more particularly to method and system for allowing a user to create actions to be taken by a server.

### BACKGROUND OF THE INVENTION

As the popularity of digital cameras grows, the desire of digital camera users to share their images with others will also continue to grow. New digital camera owners typically try to share their images based on the paradigm of film cameras, in which images are printed on paper and then placed into a photo album. The most straightforward approach to do this with a digital camera is to connect the digital camera directly to a printer to create the prints, and then manually insert the images into a photo album. Users often find this process somewhat complicated and restrictive because standard printers require particular types of paper and there is the need to constantly replace the ink cartridges. And even after the photo album has been assembled, the printed images are not easily shared with many people.

The best approaches to photo-sharing take advantage of the Internet. One such approach is for users to store the digital images on a PC and then send the images to others using email. Several Internet companies now offer an even more convenient approach by providing photo-sharing websites that allow users to store their images for free and to arrange the images into web-based photo albums. Once posted on a photo-sharing website, others may view the images over the Internet.

While it is convenient for storing digital images, getting the images to the photo-sharing websites and then manipulating the images can be challenging for users. Most commonly, users must upload their images from the digital camera to a PC or by inserting the camera's flash card into the PC. From the PC, the user accesses the Internet, logs into a photo-sharing website and uploads the images. After uploading the images, the user works on the website to manually arrange the images into web albums, and add any textual information, and to send out invitations for others to view the web albums.

Some attempts have been made to somewhat automate this process. For example, United States Patent application serial number US 2002/0054224 issued to Wasula discloses a system that enables the customization of image organization and transfer of digital images from the digital camera to the host computer. The system includes a digital camera, a host computer (PC), and a network service provider. The digital camera includes a database having a plurality of customized profile tables. Each profile may indicate where the images are to be stored. Prior to capturing an image, a user selects one of the customized profiles in the database, and each image subsequently captured by the digital camera is then associated with the selected profile. In order to transfer images from the digital camera to the PC, a digital image transfer application program supplied with the digital camera must be installed on the PC. When the digital camera is then connected to the PC and the images are transferred to the PC, the profile table selected for the images is also transferred. The transfer application, which is used to communicate and transfer the images, also performs the functions specified in the profile on the images, such as transferring the images to the network server.

Although the PC to camera approaches for storing images from a digital camera onto a web photo-sharing website works reasonably well, several problems exist. One problem is that this approach requires the use of a PC or notebook computer. While many digital camera users today have PC's, there are many other consumers who would purchase a digital camera, but are reluctant to do so because they do not yet own a PC. In addition, PC-based systems, such as described in Wasula, have other disadvantages relating to how the user customizes what is to be done with the images, including:
Being restricted to batch processing and thus are difficult to integrate with photo-sharing/organizing software.
Functions in the profiles are static and do not provide a user with the ability to change the action or to select a different action.
Different profiles for each external host makes action selection confusing for the user.
The process of providing action selections to the user of the camera is done on the PC, rather than the camera.

Recent camera communications advances have improved on the PC-based approach by providing digital cameras with the ability to communicate directly to a server. For example, U.S. Pat. No. 6,167,469 issued to Safai provides client-server architecture where the digital camera executes client software, called a transport application, that enables a user to send pictures from the camera to external addresses (email). When the transport application is launched, a top-level view of the functions available in the transport application is displayed to the user. The functions include selecting address, choosing a photo, recording a voice message, and sending a photo. Safai requires executable client code on the camera that is specific to each action to fulfill each function. For example, when a mail function is selected, code on the camera sends selected photos and email addresses of the recipients to the server, and the server then forwards an email to the recipients.

Although the client-server architecture of Safai may provide benefits over PC-based systems, such client-server approaches also have drawbacks including:
Requires function specific software to execute on both the client and the server.
The functions provided by the client application are hard-coded in the relationship between the client-side code and the server-side code, and are therefore fixed and implicit.
Difficult to maintain and support due to issues of versioning, distribution, device compatibility, etc.
Requires significant client device resources for storage and execution of the client software, even when not in use.
The client software is not likely to be downloaded on demand due to the size of client executable.

Accordingly, what is needed is an improved method and system for allowing a user to create actions to be taken by a server on data objects, such as files. The present invention addresses such a need.

### BRIEF SUMMARY OF THE INVENTION

The present invention provides a method and system for allowing a user to create actions to be taken by a server. One aspect of the present invention includes; in response to a user accessing the server from a client device, providing the user with an option to create an action item, wherein the action item represents an action that can be taken with respect to at least one data object accessible to the server; enabling the user to associate an executable software object with the action item; and in response to the server receiving an identification of the action item and an identification of at least one data object, invoking the executable software object associated with the identified action item for automatically performing the action selected by the user on the at least one data object. In a further aspect of the present invention, the server also enables the user to create a recorded action item by recording a sequence of user actions with the server.

According to the method and system disclosed herein, the present invention reduces the amount of navigation and key presses required on the client device to configure and invokes the actions, and minimizes the use of client resources for storage and processing the actions because all processing takes place on the server (or a remote server). In addition, the present invention allows the set of action items to be customized by the user based on the task being performed.

### BRIEF DESCRIPTION OF SEVERAL VIEWS OF THE DRAWINGS

FIG. 1 is a diagram illustrating a system for allowing a user to specify actions that are to be automatically performed on files uploaded from a client device to the server.

FIG. 2 is a flow diagram illustrating the process for allowing a user to specify actions that are to be automatically performed on files uploaded from a client device to a server in accordance with a preferred embodiment.

FIG. 3 is a diagram illustrating an example action list 182 displayed on the screen of a camera phone.

FIG. 4 is a flow diagram illustrating the processing of action list by the client and server in response to a user initiated task on the client device.

FIGS. 5A-5C are diagrams illustrating formats for a predefined hosted action item, a recorded action item, and remote action item, respectively.

FIG. 6 is a flow diagram illustrating the process for allowing a user to create one or more action items in a preferred embodiment of the present invention.

FIG. 7 is a flow diagram of the process for allowing the user to create a recorded action in further detail in accordance with a preferred embodiment of the present invention.

### DETAILED DESCRIPTION OF THE INVENTION

The present invention relates to a method and system for allowing a user to create actions to be taken by a server. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

A first aspect of the present invention provides a server-side architecture for allowing a user to specify actions that are to be automatically performed by a server on data objects, such as images, that have been uploaded from the user's client device. A second aspect of the present invention provides a method and system for allowing the user to create individual action items that may be automatically performed by the server on data objects accessible by the server, regardless of the objects' origins.

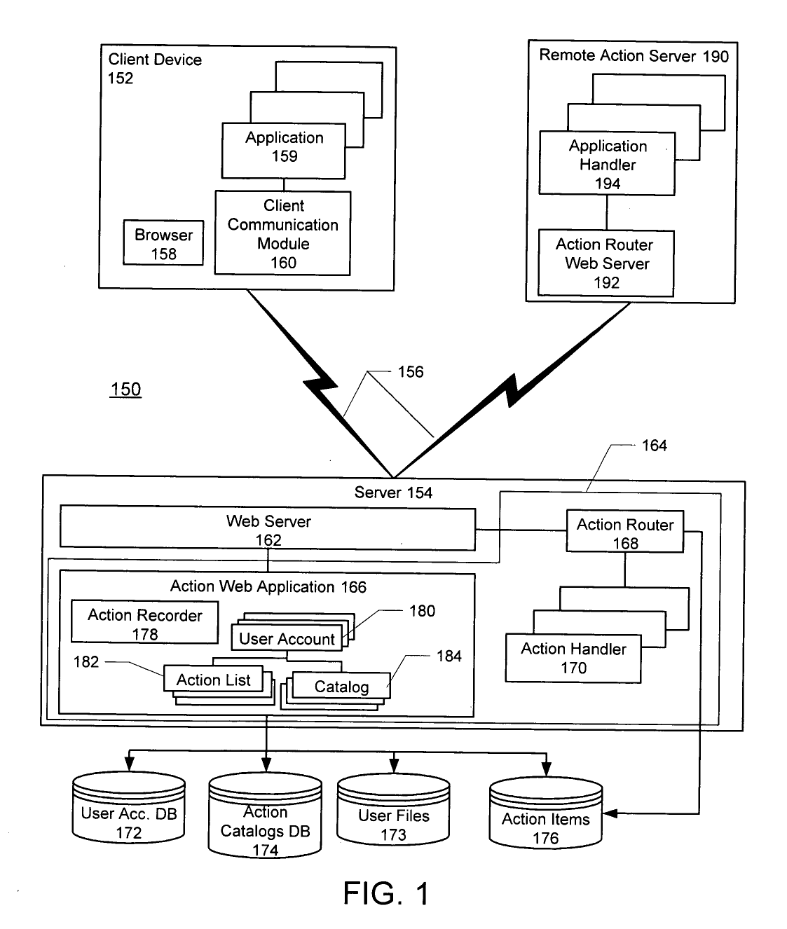

FIG. 1 is a diagram illustrating a system for allowing a user to specify actions that are to be automatically performed on data objects uploaded from a client device to the server. In accordance with a preferred embodiment, the system 150 is implemented as a server-side architecture that includes a client device 152 and server 154 that communicates over a network 156, such as the Internet. The server 154 is preferably maintained by a service provider, such as an online photosharing site. Although the client device 152 may be implemented as any computing device capable of a network connection (wired or wireless), such as a PC, in a preferred embodiment, the client device 152 is a wireless image capture device, such as a camera phone and the like. The client device 152 is equipped with a standard web browser 158 and a client communication module 160 that enables the client device 152 to communicate with the server 154. Although the present invention will be described in terms of a preferred embodiment where the client device 152 stores files that are uploaded to the server 154, the client device 152 may store and upload to the server 154 any type of data or data objects, including files and database objects, for instance. The types of files that may be stored on the client device 152 are preferably image files, but may also include audio, text, and video file types.

The server 154 includes a standard web server 162 for hosting and providing access to content and for responding to requests received from web browsers 158. According to the preferred embodiment, the server 154 further includes means for maintaining and processing user configurable action lists (collectively 164), which includes an action Web application 166 for controlling processing of action items, one or more executable software objects called action handlers 170, an action router 168 for invoking the action handlers 170, and several databases. The databases may include a user account database 172 for storing user account information, a user file database 173 for storing files uploaded by the user, an action catalog database 174 for maintaining action item lists that are available for use and action item lists that are activated, and an action item database 176 for storing individual action items that are made available to users for inclusion in action lists created by users. The web application includes an action recorder module 178 for recording interactions with the user to create a custom action item, user accounts 180 that store the action preferences and settings of each user, the action lists 182 of each user, and catalogs 184 of the action lists of each user, as explained further below. In a preferred embodiment, the server 154 is maintained by an online photo sharing/hosting service that offers configurable actions to registered users as a service.

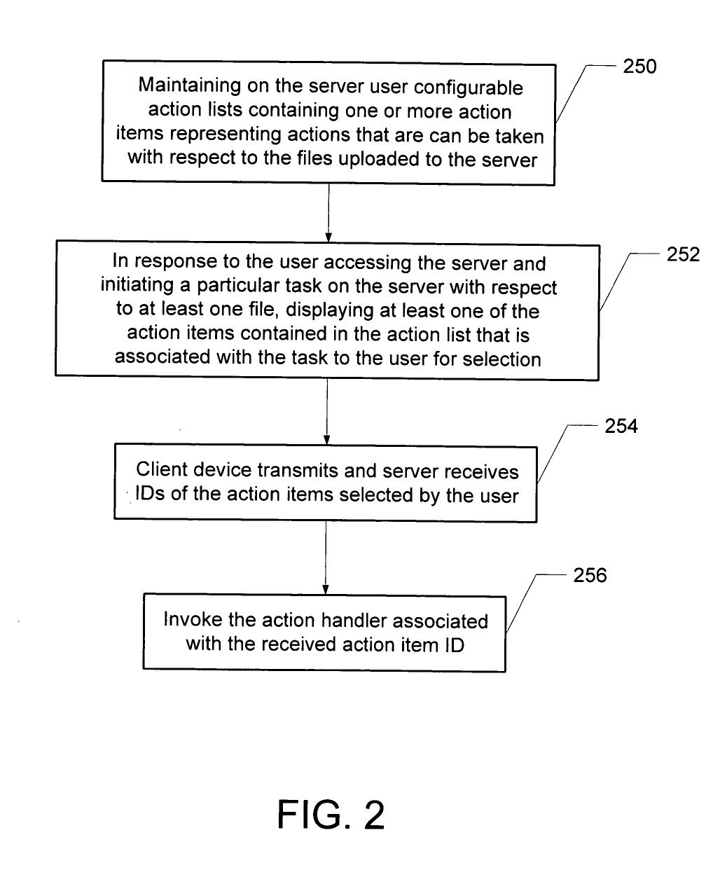

FIG. 2 is a flow diagram illustrating the process for allowing a user to specify actions that are to be automatically performed on files uploaded from a client device to a server in accordance with a preferred embodiment. The process begins in step 250 by maintaining on the server 154 user configurable action lists 182 containing one or more action items representing actions that can be taken with respect to the files uploaded to the server 154. In a preferred embodiment, the action lists created by each user are task specific and are stored in the action catalog database 174. Each of the action items comprising the action lists are stored in the action item database 176 and are associated with an action handler 170. The action handlers 170 are executable software objects located on the network in the server 154 or a remote sever 190 that performs the specified action on the file. In an alternative embodiment a single action handler 170 may be implemented to perform several actions on files, such that different action items map to that one action handler 170.

Examples of actions and corresponding action items include sending the files to a specified recipient(s) as an email or to a specified location for storage, printing the files, and processing the files in some manner, for instance.

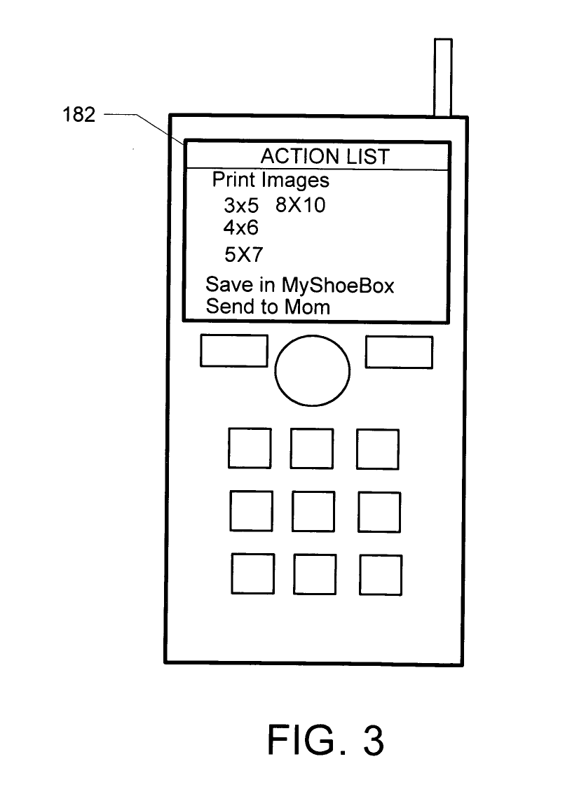

FIG. 3 is a diagram illustrating an example action list 182 displayed on the screen of a camera phone. The action list 182 is specific to the task of uploading images and is shown displaying three major options; printing the uploaded images, saving the uploaded images in the user's shoebox, and sending the images to Mom. Under the printing option, the user may select from various size prints.

According to a further aspect of the preferred embodiment, each of the action lists 182 may be associated with a different task the user can perform on the files that are uploaded to the server 154. The most common tasks performed by the user may be to UPLOAD files, such as images, from the client device 152 to the server 154, and to VIEW the files once on the server. In a preferred embodiment, the files are uploaded from the client device 152 to the server 154 via the web browser 158. In an alternative embodiment, the files are uploaded via other applications 159 (e.g., an image editing application).

Besides UPLOADING and VIEWING, the user may perform other tasks on the files after they are uploaded to the server 154, such as EDITING, ORGANIZING, and SHARING files. In a further aspect of the present invention, the user may specify action lists 182 to be made available in each of these task contexts. For example, a user may indicate the actions “Rotate”, “Copy to Family Album”, “Copy to Friends Album”, “Send Prints to Mom”, etc be associated with the user's UPLOAD task. When the user is uploading images either via a browser 158 or by an application 159, these actions are available to the user. Thus, the user may associate for each user task one or more action lists 182, and of the each action lists 182 may include one or more action items. The process of creating/configuring action lists is explained below.

In step 252, in response to the user accessing the server 154, preferably via a web browser, and initiating a particular task on the server 154 with respect to at least one file that has been or is currently being uploaded to the server 154, at least one of the action items contained in the action list associated with the task are displayed to the user for selection. The files that were previously uploaded may be the files provided by the user initiating the task, or files provided by a user other than the user initiating the task.

In a preferred embodiment, the server 154 only downloads an identification (ID) of each of the action items in an action list to the client device 152 and optionally a text description or name of the action. The action items can be presented as a pop-up/down menu items to be selected on a page of a browser, and so forth. The action lists 182 may also be nested. For example, if the user selects the print option from one action list 182, another action list 182 may be displayed that allows the user to select from various size prints, with each action listed as a separate item, e.g., “Send 4×8 prints”, “Send 5×7”.

In step 254, after the user selects the action items, the server 154 receives the ID of the action items selected by the user, which were transmitted by the client device 152. For example, if the task being performed is a file upload, then both the selected files and the selected action IDs are transmitted from the client device 152 to the server 154. If the action is to EDIT files, then the names/IDs of the files to be edited along with the IDs of the selected action would be uploaded to the server 154.

Each action ID is preferably transmitted as a single series of characters or numbers, such as name, number, or command, for instance, that is sufficient to identify the corresponding action handler 170 to the action router 168. In one embodiment, the ID of the action and the name of the action may be one in the same.

According to one aspect of the present invention, because of the server-side architecture, neither the browser 184 or other applications 159 in the client device 152 perform any preprocessing of the files in order to transmit the action item ID's to the server 154. In addition, because only the IDs of the action items are required for transmission, transmission bandwidth may be reduced.

In step 256, the web server 162 receives the transmission from the client device 152 and passes it to the action router 168, which then uses the received action item ID to invoke the action handler 170 associated with the action item ID and the selected action is automatically performed on the uploaded files.

An action item can be associated with a task such that the action item is executed either just before or after the completion of the task. Or an action item can be processed when it is selected independent of the task the user is engaged in. For example, Upload actions typically occur immediately after the image upload, although album creation may be an exception. Tasks available while viewing are more typically immediate, such as “Send to Mom”. Note that all actions are associated with one or more types of files that they take as input. Actions are only made available to the user if the user is working with a file of a compatible type.

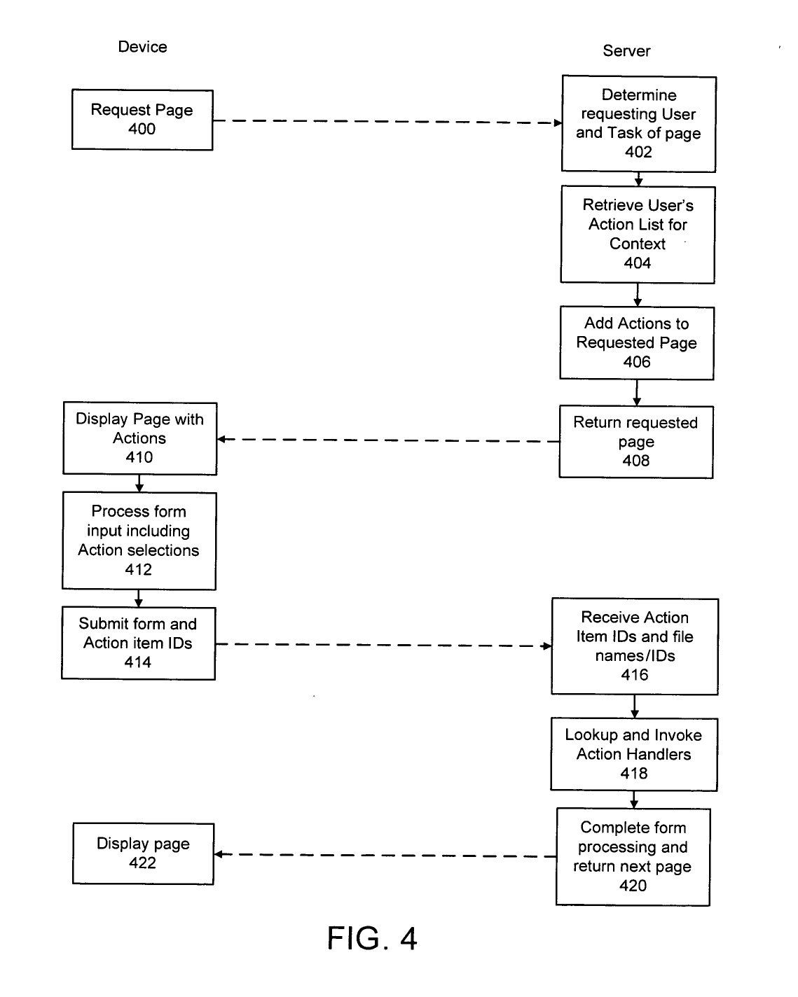

FIG. 4 is a flow diagram illustrating the processing of action list 182 by the client device 152 and the server 154 in response to a user initiated task on the client device 152. This process is independent of the type of data object the action is being performed on, e.g., images or text. In the preferred embodiment, where the user interacts with the service from the client device 152 via the browser 158, the process begins in step 400 when the user navigates to a particular page hosted by the server 154 and the browser 158 submits a page request. In step 402, the request is received by the web server 162 and passed to the action Web application 166, which then determines the requesting user and the task being performed of the requested page. In step 404, the action Web application 166 retrieves the user's action list 182 associated with the task being performed. In step 406, the action Web application 166 inserts the IDs/names of the action items from the action list 182 to the requested page. In a preferred embodiment, this is accomplished by inserting the IDs/names as links or form controls such as buttons, check boxes, etc., for allowing the user to select the actions desired. In step 408, the requested page with the action items is downloaded to client device 152. In the alternative embodiment where the user is accessing the server 154 through an application 159, the action item IDs/names would be returned to the requesting application 159.

After the requested page is received, in step 410, the browser 158 displays the page with the listed action items to the user. In step 412, the browser 158 processes the form inputs, including action item selections. In step 414, the form along with the IDs of the selected action items are submitted to the server 154. In addition, the names/ID of the files on which the action is to performed that are already on the server or are currently being uploaded are also submitted.

In step 416, the action Web application 166 receives the action IDs and file name/ID in the response sent from the client device 152 and passes the action IDs and data object identifiers (e.g., file names) to the action router 160. In step 418, the action router 168 looks up and invokes the action handlers 170 corresponding to the action IDs, which then perform the request actions on the identified files. In step 420, form processing is completed and the next page is returned to client device 152 for display in step 422.

Action List and Action Item Creation

Action lists are created by the user accessing a web page hosted on the server 154 that provides an option to “create an action list.” When this option is chosen, a web page of action items retrieved from catalogs 184 associated with the user's account and generic action items from the action item database 176 may be displayed for user selection. The user may also specify which task the action list is to be associated with. Action lists 182 created by a particular user may be stored in the user's catalog 184 under the user's account 180.

In a preferred embodiment, the service provider provides a set of predefined hosted action items that are displayed from a menu, directory, etc. to the user when creating an action list. However, in a further aspect of the present invention, not only does the server 154 allow users to configure their own action lists 182, but also allows the users to create action items. Thus, the action items displayed from a menu, directory, etc. to the user when creating an action list may include predefined hosted action items that are provided by the service provider, and user created action items that are created by the user. In a preferred embodiment, the following type of action items may be created/provided: hosted action items (which include predefined and user-defined), recorded actions, and remote actions.

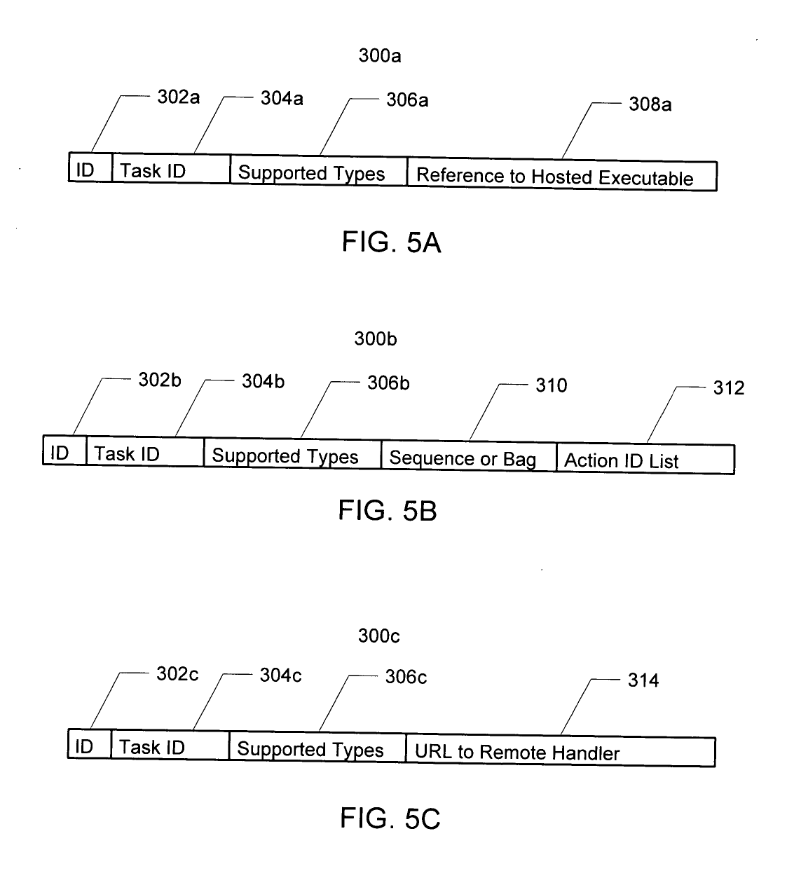

FIG. 5A illustrates the format of a predefined or user defined hosted action item 300a. Predefined action items 300a are provided by the service provider, rather than created by the user. The predefined hosted action item 300a includes an ID/name field 302a for storing the action item ID, a task ID 304a or IDs for storing the ID of the task(s) the action item is associated with, a supported types field 306c for storing the file type(s) the action supports, and an action handler field 308 for storing a reference to the corresponding action handler 170. To allow users to create an action list, the service provides a set of web pages that allow users to find and navigate through the set of actions items 300a-c provided by the service or other users. Only the ID/names of hosted action items 300a-c need to be displayed to the user. An optional description field may be provided to store descriptions which may be presented to the user to aid in understanding what the action does and when it may be used. To add an action item 300a-c to an action list 182, the user selects the action item 300a-c and the action list 182 it is to be added to. The user may modify the name of the action so that it has more meaning, is easier to read, etc.

The second method for creating an action item is to create a recorded action item from a sequence of user interactions with the server that are recorded by the service provider. The user may indicate to the service that an action or series of actions performed on or with an object (e.g., image) is to be “recorded” and made available as an action for objects of compatible types. Thereafter, the action recorder 178 records user interactions with the server 154. When the user is done recording, the user provides a name for the action and may add it to an action list 182, or place it in an action catalog 184 for use in an action list 182 at some other time.

FIG. 5B illustrates the format of a recorded action item 300b. The recorded action item 300b includes an ID/name field 302b for storing the action item ID, a task ID or IDs 304b for storing the ID(s) of the task(s) the action item is associated with, a supported types field 306b for storing the file type the action of supports, a recording type field 310, and an action ID list 312. The recording type field 310 either indicates that the recording type is a sequence or a bag. A sequence means that the recorded actions are executed in series order. A bag means that the recorded actions are executed in parallel or in any sequence chosen by the server. The action ID list 312 includes the references to the action handler executable(s) 170 responsible for performing each of the recorded actions.

The third method for creating an action item is to enable the user to associate an executable with a new action. This feature is supported in at least two ways referred to herein as user-defined hosted actions and remote actions. User-defined hosted actions may require that a user upload an executable, such as a script, which is compatible with the services action plug-in API. The executables may be signed to verify the provider and must be certified as “safe” according to the standards established by the provider. The executable uploaded for a user-defined hosted action is included with the set of action handlers 170 and is executed on the server 154 or another server made available by the service provider.

Remote actions are hosted and processed outside of the service provider on a remote action server 190, which may also include an action router 192 and one or more action handlers 194 (FIG. 1). In a preferred embodiment, a remote action item is maintained in the action item database 176 with an action item ID, a URL, and one or more supported file types. The URL identifies the remote action server 180 to which the action request is to be forwarded for processing.

FIG. 5C illustrates the format of a remote action item 300c. The remote action item 300c includes an ID/name field 302c for storing the action item ID, a task ID or IDs 304c for storing the ID(s) of the task(s) the action item is associated with, a supported types field 306c for storing the file type the action of supports, and a URL filed 314 for storing the URL of the remote action server 190.

In a preferred embodiment, the third method for creating an action item by allowing the user to associate an executable with a new action is accomplished by the following process. In response to a user accessing the server 154 from a client device 152, the server 154 provides the user with an option to create an action item, which as described above, represents an action that can be taken with respect to at least one data object accessible to the server. The data object may or may not have been provided by the user that creates and invokes the action item. Thereafter, the server 154 enables the user to associate an executable software object with the new action item. In response to the server 154 receiving an identification of the action item and an identification of at least one data object, the executable software object associated with the identified action item is invoked for automatically performing the action selected by the user on the at least one data object. In a preferred embodiment the uploaded executable software objects are stored as action handlers 170.

The user may publish action items from their action catalog(s) 184 so that they may be used by other users. Thus, action lists 182 may be associated with individuals, groups, or made public and given the requisite permissions. In this way, new services can easily be provided by the community of users of the service.

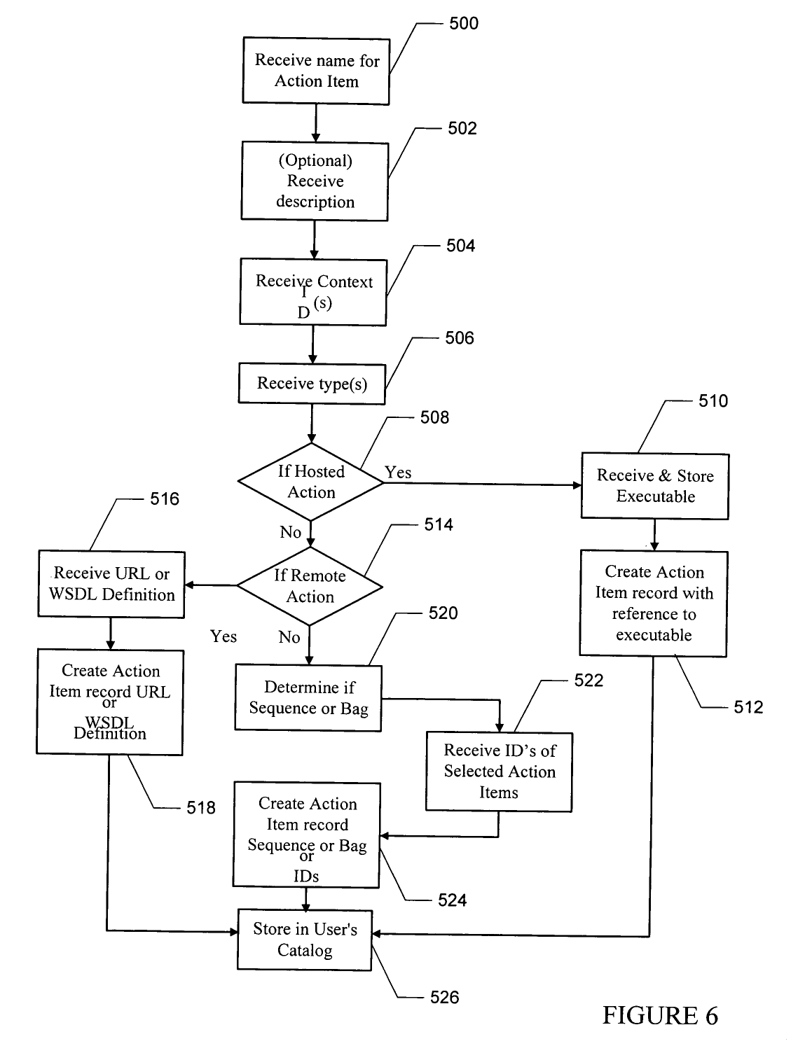

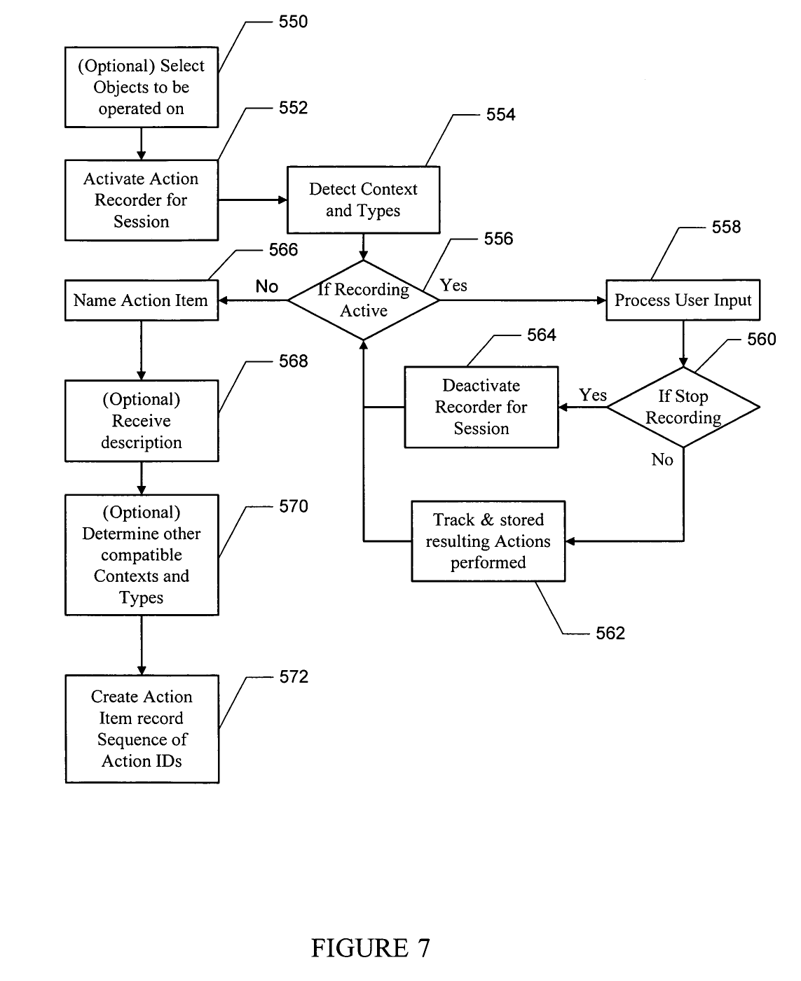

A web page hosted by the server 154 may provide the user with an option to “create an action item.” When this option is chosen, the user is guided through the process of creating user-defined hosted actions and remote actions, as described in FIG. 6, and recorded actions, as described in FIG. 7. Note that a user can manually create sequence or bag action handlers rather than using the recording mechanism. This is done through a user interface that allows the user to specify the type of action item and provide a list of already defined action IDs.

FIG. 6 is a flow diagram illustrating the process for allowing a user to create one or more action items in a preferred embodiment of the present invention. The process begins in step 500 in which the user initiates the creation of a new action, typically by providing a name for the new action item. In an alternative embodiment, the system may automatically generate a name/ID for the new action item. In step 502, the user optionally may provide description and help information regarding the action item. In step 504, the server 154 receives the task the action item may be associated with, as specified by the user. In step 506, the server 154 receives any object/data types specified by the user as being compatible with the action item. Some actions may be typeless, meaning that the action does not take any input data object.

In step 508, the server 154 determines if the created action item is a user-defined hosted action. If so, then in step 510, the server 154 receives an executable or script uploaded by the user that is to be invoked as an action handler 170 for this action. Preferably, any executables conform to a published application program interface (API), or a descriptor may be provided that describes the calling semantics. A number of standards exist for such descriptors including WSDL definitions for SOAP APIs. In step 510, an action item record is created in the action items database 176 with a reference to the executable.

In step 514 the server 154 determines if the action item is a remote action. If so, then in step 516, the server 154 receives a URL specified by the user that identifies the remote server 190 that will perform the action and the calling semantics for the executable object. Optionally, the user may provide a WSDL definition or equivalent to define the calling semantics if the calling semantics are not a simple HTTP Get or Post to the URL. In step 518, an action item record is created in the action items database 176 with a URL or WSDL definition.

If the action item is not a remote action in step 514, then the server 154 determines that the new action is a recorded action. For a recorded action, the user in step 520 indicates whether the recorded sequence of actions is to be executed in sequence (a sequence) or in an order determined by the server 154 (a bag). In step 522, the server 154 receives the ID's of the recorded sequence of actions. In step 524, an action item record is created in the action items database 176 with reference to the sequence or bag or IDs. The process for creating a recorded action is described in further detail with reference to FIG. 7.

In step 526, the record for the newly created action item is stored in the user's catalog 184. The user may also optionally specify other catalogs in which the action item may be published.

FIG. 7 is a flow diagram of the process for allowing the user to create a recorded action in further detail in accordance with a preferred embodiment of the present invention. The process begins in step 550 in which the user optionally selects data objects to operate on. This step may be optional because some actions do not require as input any objects to operate on. In step 552, the user activates the action recorder 178 to record a session. In step 554, the user's task is detected and saved, as well as the input types, for association with the created action item.

In step 556, the sever 154 determines if the action recorder 178 is actively recording. If so, then in step 558, the action recorder 178 processes the user's input by detecting the user's HTTP request to the server 154. In step 560, it is determined if the current request is a request to stop the recording session. If the request is not a request to stop the recording session, then the process loops, tracking each request and saving the action performed therein in step 562 along with the corresponding action IDs, and the order of the actions. When the user selects an option to stop recording in step 560, then recording for the session is deactivated in step 564.

After the recording session is deactivated, in step 566, the user is prompted to enter a name for the recorded action item. Alternatively, a name may be generated automatically. In step 568, an optional description of the recorded action item is received that is provided by the user. In step 570, other tasks and data object types compatible with the recorded action item are optionally determined.

In step 568, the user is optionally allowed to provide a description for the recorded action item. Alternatively, a description may be generated automatically from the descriptions of the sequence of actions recorded.

In step 570, the user is optionally allowed to specify other tasks that the action may be associated with and other compatible types. Alternatively, the sever 154 may automatically create a list of other tasks and types and allow the user to restrict the list.

In step 572, a record for the newly created action item is stored as a sequence in the action items database 176, and a reference to the action may be stored in the user's catalog 184. The user may also be allowed to place a reference to the action in other catalogs or the reference may be placed automatically.

A method and system have been disclosed for providing a way to allow users to specify actions that are to be performed on images. The present invention reduces the amount of navigation and key presses required on the client device to configure and invokes the actions, and minimizes the use of client resources for storage and processing the actions. In addition, the present invention allows the set of action items to be customized by the user based on the task being performed. The idea of customizing actions based on task is extended beyond the task of uploading to include the tasks of viewing, editing, organizing, and sharing the user's files after the user has uploaded them to the server 154. Other advantages of the present invention can be summarized as follows:
Given limited display size and input capabilities of client device, custom actions allow users to customize their UI, making actions available in contexts where they need them the most and eliminating actions choices which they rarely use.
Provides one click actions relevant to the current task to be available to a user.
Allows the action list to be customized (by the user and by intelligence on the server)
Requires only the name/IDs of the action items to be downloaded to the client, and only the action IDs of the selected action items to be returned to the server.
Allows scripting (e.g., for hosted and remote actions), but does not require any client-side action processing.
Requires no storage of the code that performs the actions on the client.
Works with browsers and with “action enabled” applications.
For “action enabled” applications, compatibility is maintained at the protocol level so software compatibility issues are minimized.
No requirement for executing foreign code or scripts on the client.

A method and system for allowing a user to create actions to be taken by a server has been disclosed. The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A method for allowing a user to create actions to be taken by a server, comprising:
in response to a user accessing the server from a client device, providing the user with an option to create an action item, wherein the action item represents an action that can be taken with respect to at least one data object accessible to the server;
enabling the user to associate an executable software object with the action item; and
in response to the server receiving an identification of the action item and an identification of the at least one data object, invoking the executable software object associated with the identified action item for automatically performing the action selected by the user on the at least one data object.

2. The method of claim 1 wherein the step of associating an executable software object with the action item further includes: requiring that the user upload the executable software object to the server for storage, thereby creating a user-defined hosted action item.

3. The method of claim 2 further including: specifying that the executable software object conforms to a published application program interface (API).

4. The method of claim 3 further including: allowing the user to provide a descriptor that describes calling semantics of the executable software object.

5. The method of claim 1 wherein the step of associating an executable software object with the action item further includes: requiring the user to specify a remote server that hosts the executable software object, thereby creating a remote action item.

6. The method of claim 5 further including: receiving a URL specified by the user that identifies the remote server that will perform the action and calling semantics for the executable software object.

7. The method of claim 6 further including: allowing the user to provide a WSDL definition to define the calling semantics.

8. The method of claim 1 further including: allowing the user to create a recorded action item by recording a sequence of user actions with the server.

9. The method of claim 1 further including: creating a record for the action item in an action items database with a reference to the executable software object.

10. The method of claim 1 further including: allowing the user to name the action item.

11. The method of claim 10 further including: automatically naming the action item by the server.

12. The method of claim 8 further including: enabling access to the action item from the server for user selection so that the user can create an action list of action items that are to be automatically performed on data objects.

13. The method of claim 12 further including: enabling the user to publish the action item for use by others.

14. A method for allowing a user to create actions to be taken by a server, comprising:
in response to a user accessing the server from a client device, providing the user with an option to create an action item, wherein the action item represents an action that can be taken with respect to at least one data object accessible to the server;
allowing the user to create a recorded action item by recording a sequence of user actions with the server; and
in response to the server receiving an identification of the recorded action item and an identification of the at least one data object, performing the recorded sequence of user actions to automatically perform the actions selected by the user on the at least one data object.

15. The method of claim 14 further including: allowing the user to indicate whether the recorded sequence of actions is to be executed in sequence or in an order determined by the server.

16. The method of claim 15 further including: receiving IDs of the recorded sequence of actions.

17. The method of claim 16 further including: recording the user actions by detecting a user's HTTP request to the server, and tracking the request and saving the action performed therein along with the corresponding action IDs and an order of the actions.

18. The method of claim 17 further including: allowing the user to optionally select data objects to operate on prior to beginning a recording session.

19. The method of claim 18 further including: in response to the user invoking a recording session, determining a task the user is performing for association with the created action item.

20. The method of claim 19 further including: allowing the user to specify other tasks that the created action item is associated with and other compatible types.

21. The method of claim 19 further including: automatically creating a list of other tasks that the created action item is associated with and other compatible types and allowing the user to restrict the list.

22. The method of claim 14 further including: creating a record for the recorded action item in an action item database.

23. The method of claim 22 further including: allowing the user to name the recorded action item.

24. The method of claim 23 further including: automatically naming the recorded action item by the server.

25. The method of claim 24 further including: enabling access to the recorded action item from the server for user selection so that the user can create an action list of action items that are to be automatically performed on data objects.

26. The method of claim 25 further including: enabling the user to publish the recorded action item for use by others.

27. A server-side system, comprising:
a client device including a web browser for accessing at least one data object;
a server in communication with the client device over a network for storing the at least one data object, the server further includes means for allowing a user to create actions to be taken by a server by,
in response to a user accessing the server from the client device, providing the user with an option to create an action item, wherein the action item represents an action that can be taken with respect to the at least one data object accessible to the server;
creating the action item by at least one of,
enabling the user to associate an executable software object with the action item, and
allowing the user to create a recorded action item by recording a sequence of user actions with the server; and
in response to the server receiving an identification of the action item and an identification of the at least one data object, invoking the executable software object associated with the identified action item for automatically performing the action selected by the user on the at least one data object.

28. The system of claim 27 wherein the action item means include: an action Web application for controlling processing of action items, and an action router for invoking one or more executable software objects, and several databases.

29. The system of claim 28 wherein the executable software objects are action handlers.

30. The system of claim 29 wherein the databases include a user account database for storing user account information, a user data object database for storing data objects uploaded by the user, and an action item database for storing action items.

31. The system of claim 30 wherein the web application further includes an action recorder module for recording interactions with the user to create a custom action item, user accounts that store the action preferences and settings of each user, and means for allowing to create action lists from the action items.

32. The system of claim 31 wherein the server is provided by an online photo sharing/hosting service that offers configurable actions to registered users as a service.

33. The system of claim 32 wherein at least a portion of the executable software objects are stored and processed on remote servers on the network.

34. The system of claim 27 wherein the client device interacts with the server via the web browser and no preprocessing of the at least one data object is required in the client device in order to transmit the action ID's of the selected action items to the server.

35. A computer-readable medium containing program instructions for allowing a user to create actions to be taken by a server, the program instructions for:
in response to a user accessing the server from a client device, providing the user with an option to create an action item, wherein the action item represents an action that can be taken with respect to at least one data object accessible to the server;
creating the action item by at least one of,
enabling the user to associate an executable software object with the action item, and
allowing the user to create a recorded action item by recording a sequence of user actions with the server; and
in response to the server receiving an identification of the action item and an identification of the at least one data object, invoking the executable software object associated with the identified action item for automatically performing the action selected by the user on the at least one data object.
